(19) United States
(12) Patent Application Publication
(10) Pub. No.: US 2020/0366743 A1
(43) Pub. Date: Nov. 19, 2020

(54) MEGAMODEL DRIVEN PROCESS ENACTMENT

(71) Applicant: TELEFONAKTIEBOLAGET LM ERICSSON (PUBL), Stockholm (SE)

(72) Inventors: Guillaume DUPONT, Epinal (FR); Sadaf MUSTAFIZ, Montreal (CA); Ferhat KHENDEK, Montreal (CA); Maria TOEROE, Montreal (CA)

(73) Assignee: TELEFONAKTIEBOLAGET LM ERICSSON (PUBL), Stockholm (SE)

(21) Appl. No.: 16/642,320

(22) PCT Filed: Aug. 30, 2018
(86) PCT No.: PCT/IB2018/056641

§ 371 Date: Feb. 26, 2020

Related U.S. Application Data
(60) Provisional application No. 62/553,311, filed on Sep. 1, 2017.

(51) Int. Cl. H04L 29/08; G06F 9/50

(52) U.S. Cl. CPC H04L 67/16; G06F 9/5077

(57) ABSTRACT

Automation of the design and management of network services is achieved by automating the enactment of a process model. The process model models activities and ordering among actions in a process for the network services. Each activity includes a set of actions and each action is associated with a model-based transformation which transforms one or more input models into one or more output models. A megamodel is constructed. The megamodel incorporates the process model and describes relations among resources to be used by model-based transformations of the process model. The resources include models and meta-models. Based on the megamodel, a transformation chain is generated. The transformation chain contains coordinated sequences of the model-based transformations. The transformation chain is enacted to thereby enact the process model for the network services.

### CROSS-REFERENCE TO RELATED APPLICATIONS

This application claims the benefit of U.S. Provisional Application No. 62/553,311 filed on Sep. 1, 2017.

### TECHNICAL FIELD

Embodiments of the invention relate to the enactment of a process model using model-driven techniques.

### BACKGROUND

Cloud computing is a major breakthrough in recent years in computer science, and is a very efflorescent domain, being more and more used by everyone (from individual customers to IT companies). In essence, cloud computing is the domain of virtual machines, which are entities that only exist in the memory of other machines. A main goal of cloud computing is to provide infrastructure, platform and software as a service, shielding users from most of the technicalities that come when building and maintaining physical machines by providing virtual computing, storage and network. Indeed, a network node, or more generally a network function can be virtualized, leading to what is called a Virtual Network Function (VNF), in an overall process called Network Function Virtualization (NFV). NFV enables the design of an entire service (including servers, router, firewall and so on) that can be hosted on a machine, virtual or physical.

The NFV paradigm is making way for the rapid provisioning of network services (NS). Defining a process for the design, deployment, and management of network services and automating the process is therefore highly desirable and beneficial for NFV systems. Automating the end-to-end management of network services, that is, enacting the workflow or process for network service management without manual intervention remains a major challenge for network operators and service providers. The European Telecom Standards Institute (ETSI) has recently launched a zero-touch network and service management group. The challenges of 5G also trigger the need for a radical change in the way networks and services are managed and orchestrated.

The wide variety of technologies, needs, users and designers makes it difficult to create a proper network service, especially with respect to requirements such as availability.

The use of model-driven orchestration means has been recently advocated in the context of NFV systems. Model management approaches sometimes use megamodels which provide structures to avoid the so-called “mega-muddle,” that is, a complicated set of relations between resources leading to an occultation of their semantics, their origins, where they are involved, etc. A megamodel contains artifacts (which include models), relations between them (which include transformations), and other relevant metadata. Megamodels have already been used in various domains, especially in software engineering. Megamodels can be tailored to fit specific needs; however, their high level of abstraction makes them difficult to use as they are.

### SUMMARY

In one embodiment, a method is provided for automating design and management of network services. The method comprises obtaining a process model which models activities and ordering among actions in a process for the network services. Each activity includes a set of actions and each action is associated with a model-based transformation which transforms one or more input models into one or more output models. The method further comprises: constructing a megamodel which incorporates the process model and describes relations among resources to be used by model-based transformations of the process model, wherein the resources include models and meta-models; generating, based on the megamodel, a transformation chain containing coordinated sequences of the model-based transformations; and enacting the transformation chain to thereby enact the process model for the network services.

In another embodiment, there is provided a network node comprising processing circuitry and memory. The memory stores instructions executable by the processing circuitry to automate design and management of network services. The network node is operative to obtain a process model which models activities and ordering among actions in a process for the network services. Each activity includes a set of actions and each action is associated with a model-based transformation which transforms one or more input models into one or more output models. The network node is further operative to: construct a megamodel which incorporates the process model and describes relations among resources to be used by model-based transformations of the process model, wherein the resources include models and meta-models; generate, based on the megamodel, a transformation chain containing coordinated sequences of the model-based transformations; and enact the transformation chain to thereby enact the process model for the network services.

In yet another embodiment, there is provided a network node operable to automate design and management of network services. The network node includes an input module operative to obtain a process model which models activities and ordering among actions in a process for the network services. Each activity includes a set of actions and each action is associated with a model-based transformation which transforms one or more input models into one or more output models. The network node further includes a megamodel construction module operative to construct a megamodel which incorporates the process model and describes relations among resources to be used by model-based transformations of the process model, wherein the resources include models and meta-models. The network node further includes a transformation chain generation module operative to generate, based on the megamodel, a transformation chain containing coordinated sequences of the model-based transformations; and an enactment module operative to enact the transformation chain to thereby enact the process model for the network services.

Other aspects and features will become apparent to those ordinarily skilled in the art upon review of the following description of specific embodiments in conjunction with the accompanying figures.

### BRIEF DESCRIPTION OF THE DRAWINGS

Embodiments will now be described, by way of example only, with reference to the attached figures.

FIG. 1 illustrates an overview of an enactment approach according to one embodiment.

FIG. 2 illustrates an example of a process model according to one embodiment.

FIG. 3 illustrates the core part of a meta-megamodel according to one embodiment.

FIG. 4A and FIG. 4B illustrate an extended meta-megamodel according to one embodiment.

FIG. 5 illustrates a high-level concept of a weaving model according to one embodiment.

FIG. 6 illustrates a weaving meta-model according to one embodiment.

FIG. 7 illustrates a meta-model of a schedule according to one embodiment.

FIG. 8 illustrates the backend architecture of an enactment system according to one embodiment.

FIG. 9 illustrates an example process model according to one embodiment.

FIG. 10 illustrates a megamodel built from the process model of FIG. 9 according to one embodiment.

FIG. 11 illustrates a schedule generated from the process model of FIG. 9 according to one embodiment.

FIG. 12 illustrates an example of a process model for network service design according to one embodiment.

FIG. 13 illustrates a transformation chain generated from the process model of FIG. 12 according to one embodiment.

FIG. 14 illustrates an initial megamodel for network service design according to one embodiment.

FIG. 15 illustrates a megamodel built from the initial megamodel of FIG. 14 and the process model of FIG. 12 according to one embodiment.

FIGS. 16A, 16B, 16C, 16D, 16E and 16F illustrate examples of a user interface of a process enactment tool according to one embodiment.

FIG. 17 is a flowchart illustrating a method for automating design and management of network services according to one embodiment.

FIG. 18 is a block diagram of a network node according to one embodiment.

FIG. 19 is a block diagram of a network node according to another embodiment.

FIG. 20 is a block diagram illustrating a virtualization environment according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a model-driven approach for automated process enactment. The approach combines the orchestration of model transformation chains with model management means. To begin with, a process is modeled as a process model (PM) which is obtained as input. The process model includes activities and actions. The activities in the process model include actions and may embed other activities, and an activity may be unfolded recursively into actions. Actions are associated with model-based transformations. Model-based transformations include transformations that are themselves models or executable programs (e.g. in machine code). Input and output objects of the model-based transformation are model instances of existing domain-specific language(s).

A megamodel (MgM) is built for model management. The megamodel contains information of all resources used by the model-based transformations of the process model, as well as the link(s) (representing the relations) between these resources. The resources include models and meta-models. The process model itself is also a resource which is registered in the megamodel. To enact the process model, the megamodel is used to build a transformation chain. Token-based enactment means may be implemented to orchestrate the transformation chain.

An enactment tool has been created with NFV systems as the target domain. The model-driven approach and the tool support are not restricted to NFV, and can be used in various other domains for process enactment.

In the disclosed approach, transformation chaining is used for modeling the orchestration of different model-based transformations. A transformation chain includes coordinated sequences of model-based transformations. Orchestration languages may be used for the composition of the transformations. A transformation chain may include sequential steps of transformations. A transformation chain may also include a complex chain which incorporates conditional branches and loops; alternatively or additionally, a transformation chain may include a composite chain, which is a chain including other transformation chains.

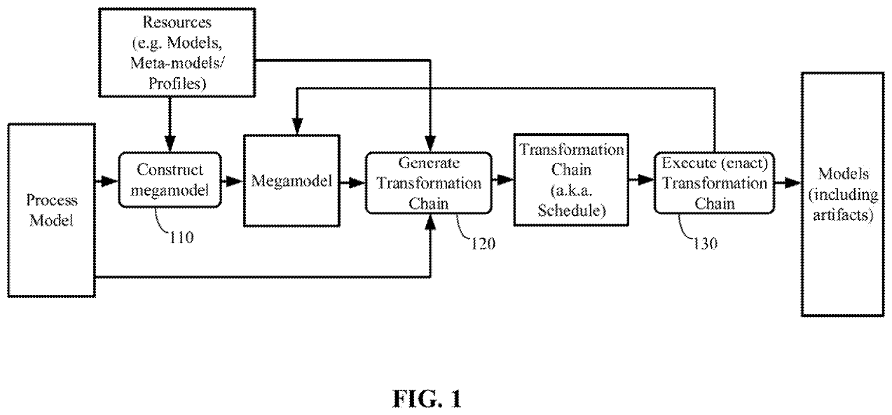

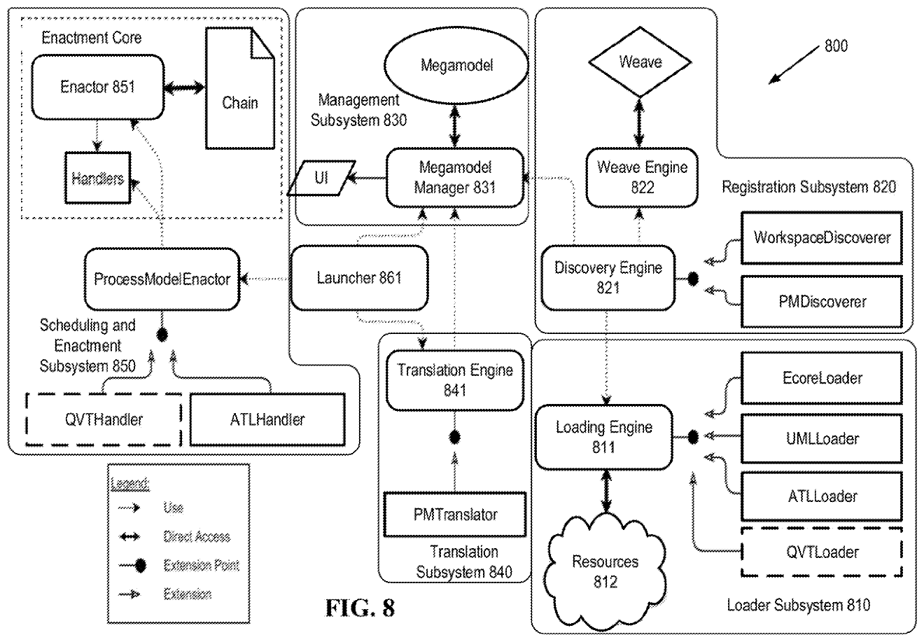

FIG. 1 illustrates an overview of the disclosed enactment approach according to one embodiment. At step 110, a megamodel is constructed based on a process model and resources such as models and meta-models (which are referred to as profiles in some instances). The process model is also a resource. The megamodel incorporates the process model and describes relations among resources to be used by model-based transformations of the process model. The megamodel may be built by an enactment system (described with reference to FIG. 8). At step 120, a transformation chain is generated. The process model is translated to the transformation chain. The transformation chain is formed by chaining the model-based transformations of the process model, and contains information such as one or more sequences of actions, transformations used, inputs and outputs of the transformations, etc. At step 130, the transformation chain is executed (i.e. enacted). The transformation chain is executed by an enacter in order to enact the processor model. The enacter is a program that can execute the correct actions in the right order, based on a schedule, namely the transformation chain.

The enacter described herein is a generic enacter that can adapt to different kinds of process models. Having a generic enacter enables the integration of different formalisms for modeling the process model, instead of having an enacter for each kind of process model.

In classical engineering, and especially computer and software engineering, software designers are often focused on low-level considerations or implementation details, e.g. specific behaviors, algorithms or data structures. However, most of the time, this focus occults the real difficulties of the studied problem, and brings the risk of creating a solution that is highly specific and hardly adaptable, which is a major flaw when it comes to the real world filled with a broad diversity of machines, systems and technologies. In this regard, creating an abstract representation (e.g. model) of the subject of the studied problem can greatly help to master the problem and to design a solution, which can then be implemented with low-level constraints. This methodology is called Model-Driven Engineering (MDE).

The following provides some definitions of MDE terminologies.

Definition 1 (Models). A model is a set of objects and relations between them.

Definition 2 (Meta-models and Conformance Relationship). A model abides by specific rules, which form a meta-model. That is, the model conforms to the meta-model. In other words, there is a conformance relationship between the model and the meta-model.

It is noted that a meta-model can also be represented as a model, and therefore can conform to another meta-model, which is called a meta-meta-model. Also, a model can conform to itself (e.g. Ecore).

Definition 3 (Transformations). A transformation represents a process on models, with associated inputs and outputs specifications (i.e. constraints on the input/output models, typically in the form of meta-models to which those input/output models conform).

Definition 4 (Megamodels). A megamodel is a structure containing models as well as relations between the models. More precisely, a megamodel is a model which has other models as objects.

The basic idea of megamodels is that everything is a model: models, meta-models, transformations and even other resources; and models can be linked together through relations, typically, conformance (as in Definition 2), and also derivation (when a model is the result of a transformation) and cross-referencing (when an object in a model is used in another model). A megamodel is a map for finding and linking together all involved models. A megamodel can be used to enforce conformance and compatibility checks between the various models and transformations. A megamodel is also useful for reusing and composing transformations in transformation chains.

The above definition of megamodels expresses a general idea of megamodels, leaving to users a choice of what, how, and to what extent to put into the megamodels. For example, a user may add a specific type of relation or remove a cross-reference relationship in the megamodel. In other words, a megamodel is a structure that contains models. What gets to put inside the megamodel is entirely up to the user.

The megamodels described herein have a high level of traceability. Every mutation (e.g. as a result of a transformation or induced by a user) that can happen to a resource can be registered with the megamodels. A megamodel with such a traceability support can be used as a repository, and enables a user to trace the version of every resource, the origin of the resources (e.g. as a result of a transformation or provided by the user), the location of the resources, whether a resource exists, etc.

Definition 5 (Process Model). A process model is a model which contains: (a) Actions: representing a task or a set of tasks, inputs and outputs, where the inputs and outputs are, in general, models; (b) Control flows: directed links between those actions that establish the order in which the actions are to be executed; and (c) Object flows: links between the inputs and outputs of actions, allowing for using the output of an action as the input of another.

A process model is used to model a process. A process model describes the ordering of various actions as well as how to interface the actions. A process model can be extended in numerous ways, thus enabling its users to define more refined structures. For example, some of the following additional concepts may be used in process models: (a) Initial and final nodes: special actions specifying respectively the beginning and the end of a process model. (b) Parallelization: actions that do not depend on each other can be executed in parallel. (c) Decision: depending on various criteria (a condition), the execution of a process model can omit some branches. (d) Parameters and Outputs: (also referred as object nodes) a way to express what can be fed in the process model or its actions and what can be retrieved from them. (e) Nested behaviors: a process model can be used to express the actual behavior of an action, leading to the definition of specific actions that actually refers to other process models.

The semantics of the process model includes: (a) Two actions that are linked with a control flow (which, being directed, has a beginning and an end), the action at the beginning is executed just before the action at the end. In this case, the actions are said to be sequential. (b) When having two sequential actions, the second one is executed only when the first one has finished. (c) Object nodes that are linked share the exact same data.

As an example, Unified Modeling Language (UML) 2.0 Activity Diagrams may be used to represent and visualize a process model. It is also possible for processes to be modeled with some other workflow modeling language, for instance, BPMN. A person skilled in the art would understand that a process model could be based on another language or technology.

Activity diagrams are typically used to model software and business processes. These diagrams allow the modeling of concurrent processes and their synchronization with the use of forks and joins. Both control flow and object flow can be depicted in the model. An activity node can be either a simple action (representing a single step within an activity) or an activity (representing a decomposable activity which embeds actions or other activities). An activity specifies a behavior that may be reused, i.e. an activity can be included in other activity diagrams to invoke a behavior. Along with the activities, the input and output models associated with each activity are also clearly identified via input and output parameter nodes (denoted by the rectangles on the activity border). Since UML 2.0 Activity Diagrams are given semantics in terms of Petri Nets, the precise formal semantics allow the activity diagrams to be simulated and analyzed.

In one embodiment, the Eclipse Papyrus Activity Diagram environment may be used to create a process model. The process model instance conforms to the activity diagram language. Each process model includes one or more activities, which are decomposable into actions. The behavior of each action is implemented with a model-based transformation. The attributes of activity nodes in the activity diagram provide information about the associated transformations. Each action in the process model is also associated with a set of input and output models. With Papyrus, all meta-models are mapped to profiles to allow model instances to be created and to be used as source or target models of the transformations.

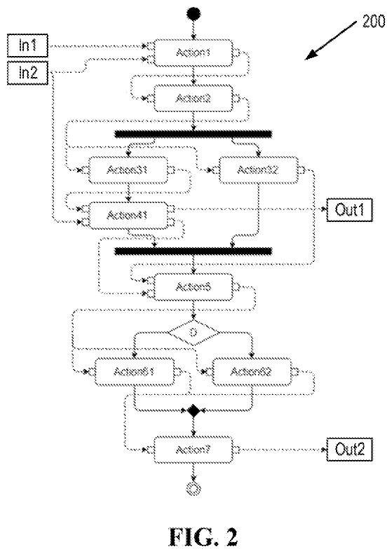

FIG. 2 illustrates an example of a process model 200 in the form of a standard UML activity diagram. The notations employed in the process model 200 include the following:

Actions are represented as rounded rectangles. Object nodes are represented as (not rounded) rectangles. Some object nodes are “attached” to the action, which means they represent an input or an output of that action. The other nodes correspond to general parameters and outputs of the process model. The initial node is represented as a dark circle, the final node as a double circle. Control flows are represented by filled arrows. Object flows are represented by dash arrows. Decision is represented as the “D” diamond. A tiny black diamond represents the end of the branches of the decision (often called merge). Parallelization is represented in between two elongated rectangles (the first rectangle is called fork and the second one is called join).

The following is a description of megamodels. One main issue in resource management is how to centralize information about resources for easy access. This issue may be resolved by devising a transformation which is expressed using heterogeneous technologies. A transformation may be an executable program (e.g. in machine code) or a model conforming to a specific meta-model, for instance, ATL, QVT, Epsilon, Java, etc.). Transformations define a precise configuration as to what to be fed in and pulled out from. This disclosure describes the use of megamodels for model management. The megamodel can be built incrementally in two steps: 1) by registering the resources, and then 2) by registering the process model.

Registering the resources: To begin with, the resources (i.e., models and meta-models/profiles) which are part of the target project are registered in the megamodel. This is carried out automatically by going through the project workspace (referred to as workspace discovery), and an initial megamodel is derived at this stage.

Registering the process model: Following the workspace discovery, the initial megamodel is incrementally built by carrying out a process model discovery. This step includes registering the process model and the associated transformations in the megamodel. Thus, the process model is incorporated into the megamodel. The process model is linked with the elements of the rest of megamodel (i.e., the parts of the megamodel outside the process model) using externalized links delegated to another system called a weaving model, which is not the process model nor the megamodel. Thus, users can reach all relevant information to enact the process model, and no constraint is imposed on the structure of the process model, effectively decoupling its meta-model from the megamodel. That is, there is no reference to the megamodel in the process model. The weaving model binds every relevant element of the process model to their corresponding resources in the megamodel, without touching the structure of either of them. The links between the process model and the rest of the megamodel are created by weaving the process model and the megamodel and storing the details in a weaving model, as will be defined below in Definition 6.

Definition 6 (Weaving model) A weaving model is a special kind of model that defines relations between the objects and relations of other distinct models (at least two). These relations are the objects of a weaving model, which is based entirely on cross-referencing.

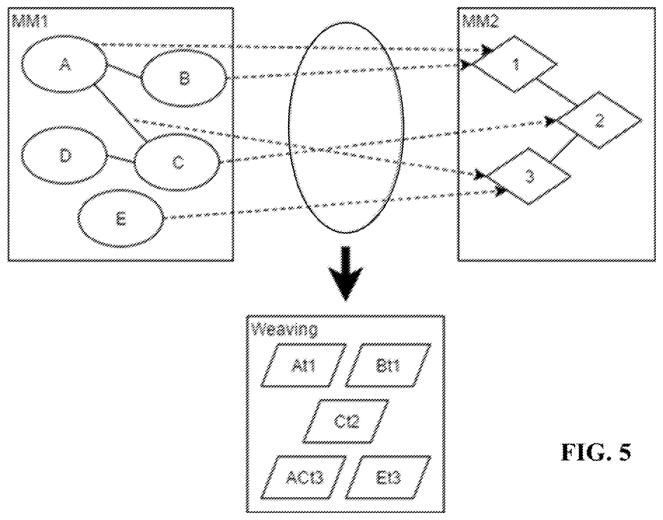

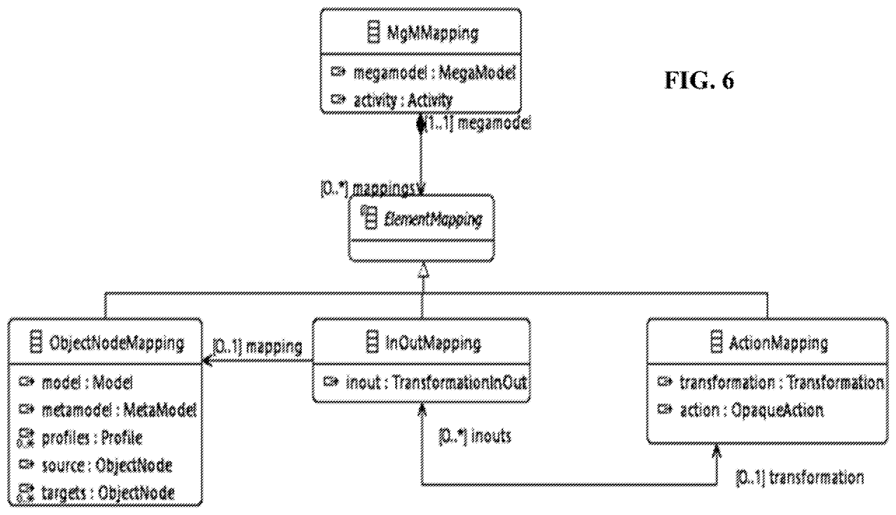

The weaving model is dependent on the process model. In other words, the weave meta-model is specific to the process model language that it weaves. Thus, if a designer adapts the environment for another process model language (e.g., expressed with BPMN), it would be necessary to create a new weaving model to bind the new type of process model with the megamodel. Further details about the weaving model will be provided with reference to FIG. 5 and FIG. 6.

The meta-model of a megamodel (also referred to as the meta-megamodel) includes two parts: a core part, which only stores the basic information about the architecture, and the traceability part, which is a useful extension. This disclosure uses Ecore-based megamodeling. However, a person skilled in the art would understand that megamodeling could be based on another language or technology.

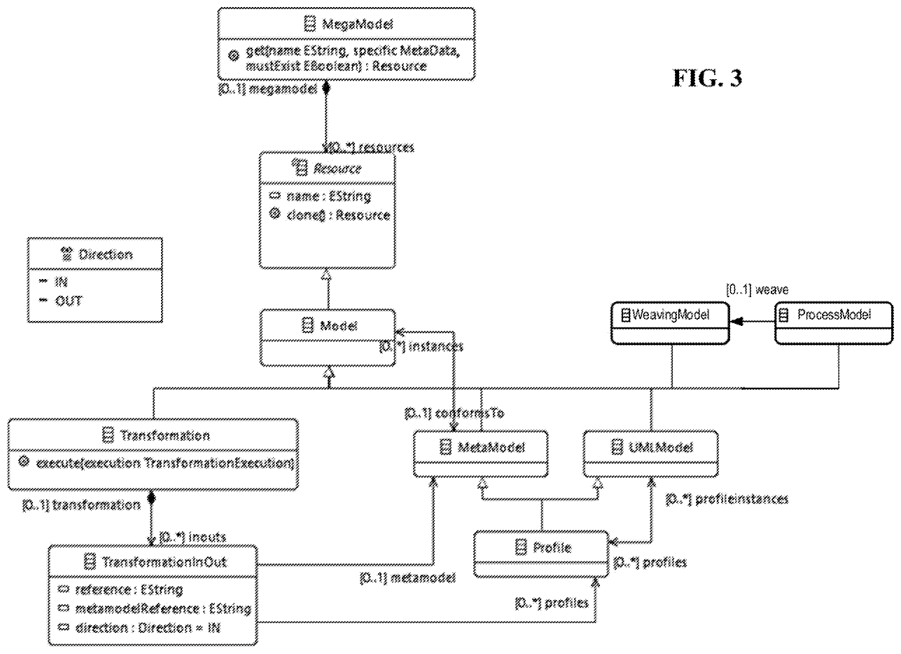

FIG. 3 illustrates the core part of a meta-megamodel according to one embodiment. A megamodel is a container for gathering resources. A resource is identified by its name. Two resources that have the same name are considered as being equal. A resource can be specialized into a model. A model can be specialized further into three categories: (a) A meta-model: such as what has been defined in Definition 2, with the conformance relation being expressed via the “conformsTo” attribute of the Model meta-class. (b) A transformation: such as what has been defined in Definition 3. (c) Any special kind of model among the types UML, weaving (such as in Definition 6) and process model (such as in Definition 5).

A specific UMLModel meta-class is provided because UML models can have one or more profiles applied to them. A UML model is thus a model conforming to UML and that can have profiles, which is unique to this case.

The Transformation meta-class: in addition to storing standard data (e.g. name and conformance), the Transformation meta-class also stores its full configuration; that is, the specification of what goes in and comes out of it, under the form of “in-outs” represented by the TransformationInOut meta-class. The TransformationInOut meta-class describes the in-out resources of a transformation. It stores the meta-model, profiles and direction of the specification (either IN or OUT; that is, each in-out resource is either an input resource or an output resource for a transformation), but also presents two attributes, reference and metamodelReference, which are the names by which the model and meta-model are referred to inside the transformation.

Typically, in a transformation (e.g. an ATL transformation), the meta-models and in-outs are referred to using their aliases. The use of aliases allows, among other things, to avoid specifying the model directly inside the transformation, thus making the transformation reusable.

An analogy may be drawn on defining the prototype of the transformation in a programmatic point of view. The meta-model reference is the name of the type (which will correspond later to an actual implementation) and the model reference is the name of the parameter (which will be filled in when executing the transformation).

The megamodel further includes two special models: WeavingModel and ProcessModel. These two models allow a user to easily map a process model to its weave.

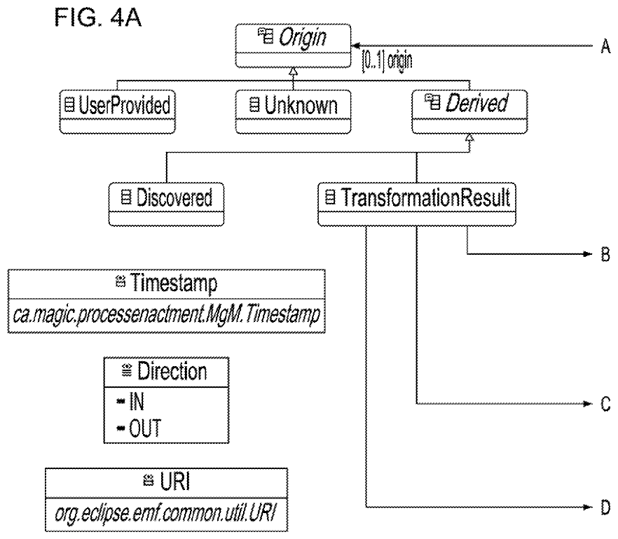

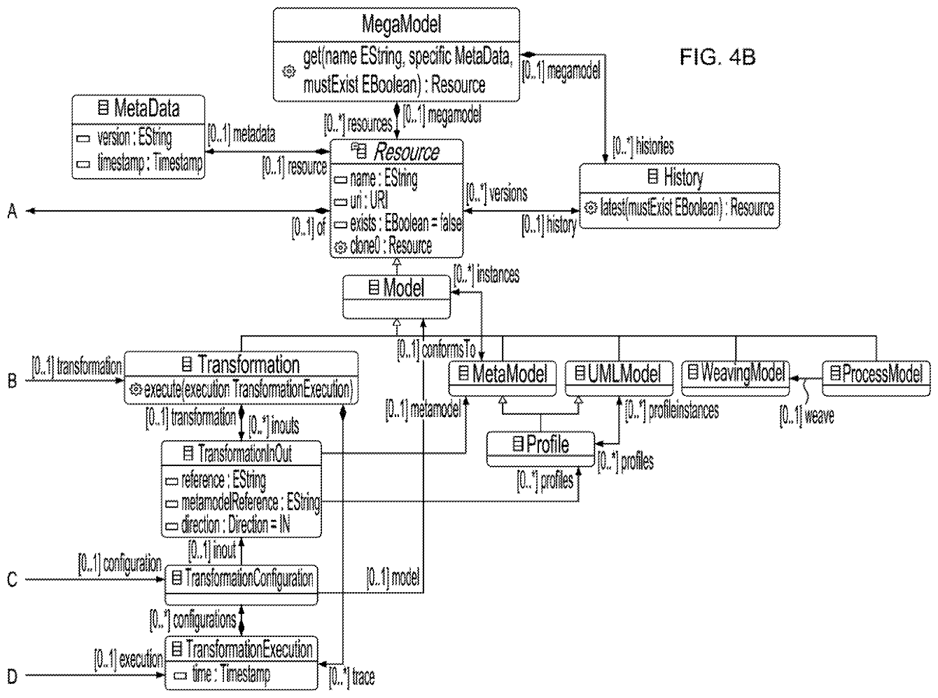

FIG. 4A and FIG. 4B illustrate a meta-megamodel extended to provide support for traceability according to one embodiment. This extension has the following features:

Every resource is given a history that traces everything that happened to it.

Every resource is given metadata, which can be of any form (e.g. a version, an author, an encoding, etc.) and includes a timestamp to express how recent the resource is. This timestamp is used to sort the history.

Every resource is given an origin to express from where the resource comes from. For example, a resource provided by the user is labeled as [UserProvided], or a resource created as a result of a process is labeled as [Derived].

Every resource is given a uniform resource identifier (URI), that is, a way to access the actual content it represents. There is also a flag called “exists” that states whether or not the resource exists. For example, the result of a transformation that has not been launched does not yet exist.

Transformations hold a trace, that is, a list of every execution that happened. A resource can then be specified as being the result of a transformation, with the corresponding configuration (e.g. actual parameters that were being fed in the transformation).

The megamodels described above are generic. A megamodel conforms to the structure provided in FIG. 3 or FIGS. 4A and 4B does not enforce what the user will be doing; it is flexible and adapts to whatever the project it is used in. For example, there is no reference to a specific meta-model (except for UML) or transformation language.

FIG. 5 illustrates a high-level concept of a weaving model, using an example of two models, the one on the left (conforming to meta-model MM1) and the one on the right (conforming to MM2). From these two meta-models, a weaving meta-model can be devised. From this weaving meta-model, a weaving model (referred to as Weaving) is generated to store the links between the model on the left and the one on the right, such as the links between the process model and the megamodel.

The weaving model maps each element of the process model to a corresponding resource. Some elements of the process model do not have to be mapped (e.g. control flows do not represent any resource), so in the end, the weaving model may not be “complete”, in that it may not contain every element of the process model.

FIG. 6 illustrates a weaving meta-model for a process model expressed as a UML activity diagram according to one embodiment. The resources in a process model are of two natures: the transformations (that are linked to some actions) and the data that is circulating in-between them (that are mapped to object nodes and object flows). The former can be expressed in the weaving meta-model using the meta-class ActionMapping.

Regarding the object nodes and object flows, it is noted that object nodes linked with one or several object flow(s) represent the same data, meaning that this data can be mapped to this object flow instead of being mapped to each element it links.

Moreover, object flows are one-to-many, meaning that an output can present several outgoing object flows but an input can only have one incoming. Thus, a set of object flows emanating from the same source and going to various targets can be mapped to the same data (model, meta-model and profiles). Basically, those considerations translate to the ObjectNodeMapping meta-class.

However, it is noted that this kind of mapping only links object flows to data; what still needs to be determined is which pin is mapped to which transformation configuration, so that in the end, an execution can be built to run the transformation. For that, an additional meta-class, InOutMapping, is used to link an input-output to a full object flow, providing information as to what goes in and comes out of the transformation it is linked to.

A process model is given translational semantics by mapping it to a transformation chain. The translation from a process model to a transformation chain takes the megamodel as input, which includes information of the process model, the weaving model, and, if applicable, additional environment information, and generates the corresponding transformation chain.

A transformation chain (also referred to as a schedule) is standalone (i.e. self-contained), meaning that it is sufficient in itself to be executed without the process model and the megamodel. A schedule is generic. Some transformations that are not directly dependent on each other may be executed in parallel.

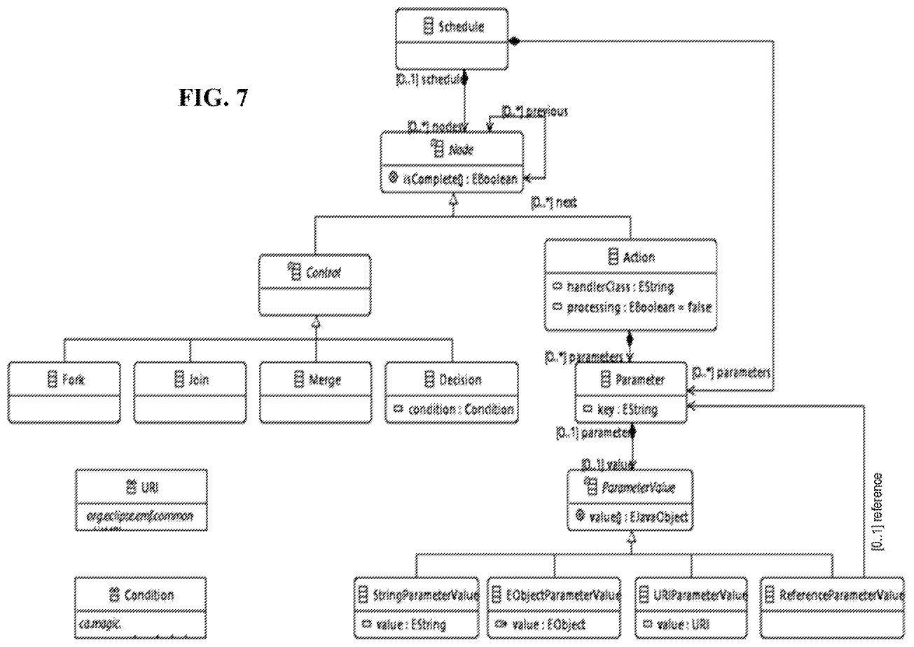

FIG. 7 illustrates a meta-model of a generic schedule expressed as an Ecore model according to one embodiment. Globally, a schedule is a chain of actions which have parameters that are fixed. Parallelization may be expressed through forks and joins, which represent respectively the beginning of a parallel section and the ending of it.

The actual behavior of an action is expressed through a handlerClass attribute. When the handlerClass attribute is associated with an enacter the action becomes meaningful and may represent a Java class, an ATL class, or a path to an executable program, etc. The children classes of ParameterValue specify the way parameters are expressed.

In addition to this meta-model, the following constraints are imposed on a schedule to control the flow of actions: (a) An action has at most one previous node and at most one next node. (b) An action with no previous node is called initial and an action with no next node is called final. (c) A fork node has at most one previous node and has at least one next node. (d) A join node has at most one next node and has at least one previous node.

In one embodiment, the schedule is associated with token-based semantics, which includes: (a) Tokens are circulating in the schedule. At every moment, one or several nodes (actions, fork or join) have a token, in which case it is said it has the control. (b) When an action receives a token, it is executed. When the action is done, it passes its token to its next node. (c) When a fork node receives a token, it passes a token to each of its next nodes, at the same time. (d) When a join node receives as many tokens as it has previous nodes, it passes one token to its next node.

Initially, a token is given to every initial node. The execution ends whenever every token circulating cannot be passed further (typically: the only nodes having a token are the final ones). Therefore, the enacter is based on controlling the tokens and activating the actions when needed.

After generating the transformation chain of actions, this chain is executed by an enacter. An enacter is a program that can execute the correct actions in the right order, based on a schedule model. An enacter does not order the actions; an enacter reads the schedule model and acts accordingly.

FIG. 8 illustrates the backend architecture of an enactment system 800 according to one embodiment. The backend architecture is an example of an extension developed for Papyrus. A person skilled in the art would understand that similar architecture could be based on another language, technology, or development tool. In FIG. 8, the core functionalities are represented using rountangles (rounded-corner rectangles). The rectangles are extensions, which can be recognized by the system for added new functionalities; but unlike the core functionalities, the system can still function without the extensions.

The enactment system 800 includes support for enacting a chain of transformations in ATL, Java, other transformation languages, or executable programs. The enactment system 800 allows for the enactment of activities in process models which include executable actions. This extension allows transformations to be written in any general purpose programming language (e.g. Java, C, Python) or executable code. It also supports other types of input and output models to be associated with activities besides UML models, such as Ecore or XMI. This feature allows integration and reuse of legacy code in the process model.

A loader subsystem 810 is centered around a loading engine 811 and also includes Resources 812 (e.g. models and meta-models), EncoreLoader, UMLLoader, ATLLoader and QVTLoader. Loaders for other languages (e.g., Java) or executable code may also be included.

The loader subsystem 810 provides a high-level interface with the actual resources of a system (i.e. a file system). The loader subsystem 810 is able to recognize the correct way of loading a file and to extract relevant data from the file into the megamodel, for example. Typically, when attempting to register a file in the megamodel, a discovery engine 821 requests the loading engine 811 to load the file so that data can be extracted from the file. Defining loaders allows different technologies to be incorporated into the enactment system 800, making the enactment system 800 capable of understanding new formats.

A registration subsystem 820 is centered around the discovery engine 821. The “discovery” is the process by which a resource is added to the megamodel. It includes the recognition of the resource (determining that it is a meta-model, a transformation, a profile, etc.) as well as the extraction of its data (Uniform Resource Identifier (URI), name, inputs and outputs, etc.). As in the case of the loaders, a custom discoverer may be developed. For instance, as shown in FIG. 8, WorkspaceDiscoverer and PMDiscoverer are examples of custom discoverers. This allows the tool to be extended with discoverers for other kinds of workflow modeling languages.

The registration subsystem 820 is also the place that weaves the process model to the megamodel, with the help of a weave engine 822. As the weave is entirely dependent on the process model language, it is noted that the weaving process is completely devolved to the discoverer, which provides both a specific weaver (an implementation) as well as filling it.

A management subsystem 830 is centered around a megamodel manager 831 and also includes the megamodel and a user interface. The subsystem 830 allows a user to access the megamodel, such as: request to register a resource, create or delete a megamodel, etc. The subsystem 830 also includes an extensive API for manipulating the megamodel, ensuring its validity throughout the process.

A translation subsystem 840 revolves around a translation engine 841 and also includes a PMtranslator. The translation subsystem 840 provides the translation of a process model to a schedule (i.e. a transformation chain) that can be enacted. The translation subsystem 840 exposes an extension point that allows users to plug their own translation means (e.g. a translation algorithm or other types of translators) if ever the users want to use another type of process model.

A scheduling and enactment subsystem 850 includes two subparts: a generic enacter (enacter 851) and an interface between the enacter 851 and the remaining part of the project, through a ProcessModelEnacter. The enacter 851 is independent of the project, and is shown inside the dashed box labeled “Enactment core” which also includes the Chain and Handlers. The interface allows to include language handlers such as QVTHandler and ATLHandler. Other language handlers, such as JavaHandler and/or ProcessHandler (which handles executable code), may also be included, for example, for interacting with a managed system.

A Launcher 861 orchestrates everything needed to execute the process model, which includes translating the process model into a transformation chain and enacting the chain. The launcher 861 also manages enactment configurations (i.e. data associated with the process model to translate and enact it), which may be stored as a standard Eclipse launch configuration.

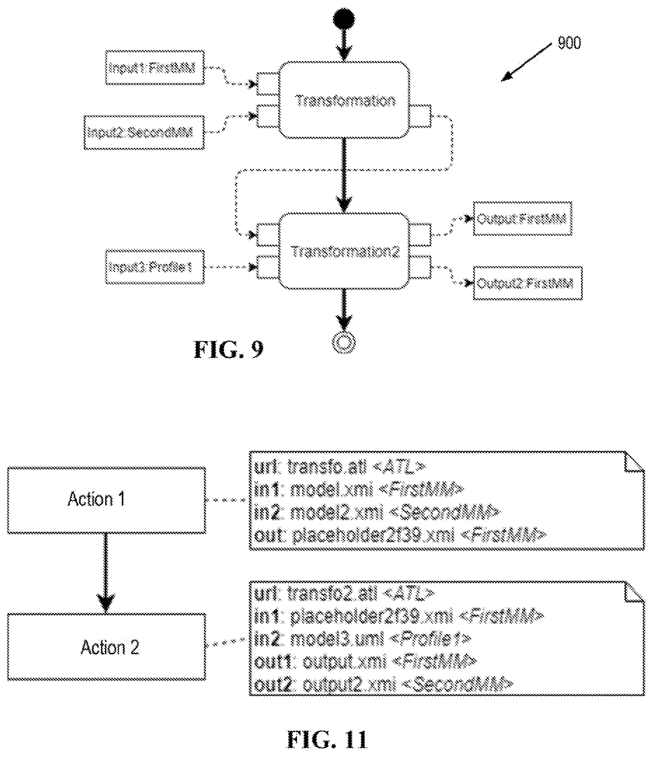

A simple example of process model enactment is presented in the following with reference to FIGS. 9-11. First, a set of resources are defined. The resources include: (a) two Ecore meta-models (FirstMM and SecondMM); (b) one UML profile (Profile1); and (c) two ATL transformations (Transformation and Transformation2)

FIG. 9 illustrates an example process model 900 according to one embodiment. In the process model 900, the label for parameters is of the form <left>:<right>. By convention, the <left> part corresponds to the name of the model mapped with this parameter, and the <right> part is that model meta-model's name. Thus, Input1: FirstMM means that the parameter is being mapped to a model named Input1 of meta-model FirstMM. Note that the <right> part cannot be empty, but the <left> part can. If the <left> part is empty, the system will request the user to fill in the model name when needed.

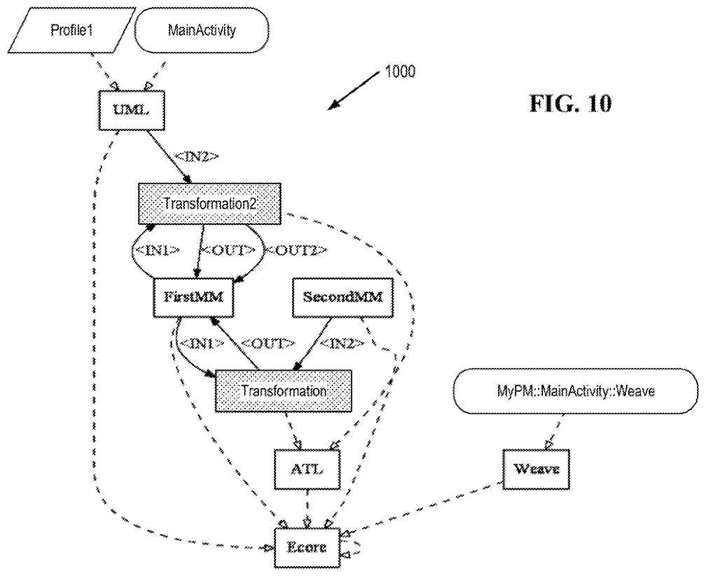

FIG. 10 illustrates a diagram of a megamodel 1000 built from the process model 900 and the other resources. Meta-models (including UML, FirstMM, SecondMM, ATL, Weave and Ecore) are shown in white rectangles, profiles (including Profile1) are shown in parallelograms, transformations (including Transformation and Transformation2) are shown in rectangles filled with dots, special models (including the process model MainActivity and the weaving model MyPM::MainActivity::Weave), are shown in rounded rectangles.

FIG. 11 illustrates a schedule (i.e. a transformation chain) generated from the process model 900 (and upon requesting the actual models to be fed in) according to one embodiment. It is noted that the frames on the right expose the configurations of each action, in the form “parameter: value <meta-model>”. This schedule can be enacted.

NFV Case Study. Automating network service design and management is one of the challenges in the NFV domain. The following example demonstrates the enactment of the network service (NS) design process, which is one of the activities of the NS management process.

An NS, such as VoIP, is a composition of Network Function(s) (NF) and/or other NSs, interconnected with one or more Forwarding Graphs (FG). These graphs interconnect the NFs and describe the traffic flow between them. Virtualized Network Functions (VNF) are the building blocks of an NS in NFV. VNFs are software pieces that have the same functionality as their corresponding Physical Network Functions (PNF), e.g., a virtual firewall (vFW) vs. a traditional firewall device. The design of an NS consists of defining an NS Descriptor (NSD), which is a deployment template capturing all this information. This template is provided to the NFV Orchestrator for the NS lifecycle management.

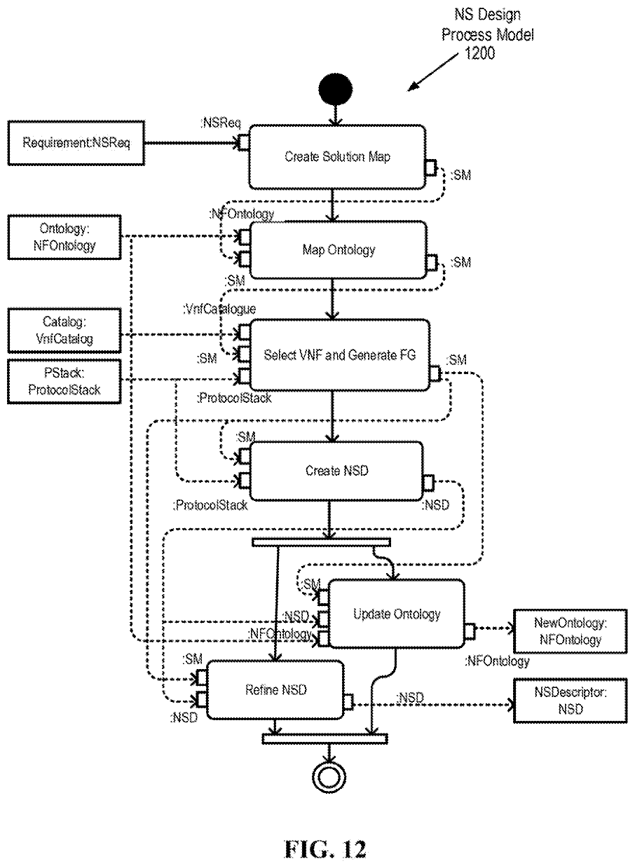

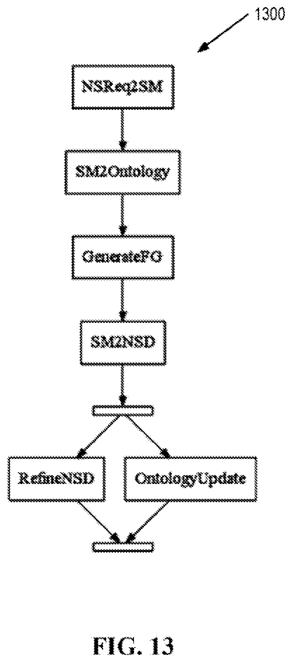

Coming up with the deployment template for an NS is not an easy task for an inexperienced tenant who has limited knowledge regarding the details of the target NS. Instead of these details, the tenant may request at some level of abstraction the functional and non-functional characteristics of the targeted NS. The gap between these NS requirements (NSReq) and the NS deployment template is filled with an automated NS design method. With the help of a network function ontology (NFOntology), it is indeed possible to fill this gap and design automatically NSDs from NSReqs. The NF ontology captures the known NF/service decompositions and their (standard) architectures. In the NS design method, the NSReq decomposition is guided by the NFOntology to a level where proper network functions can be selected from an existing VNF catalog. After the selection of the VNFs, the method continues with the design of the forwarding graphs given the characteristics of the selected VNFs and their dependencies. This generates a set of forwarding graphs, which are refined further based on the non-functional requirements in the NSReq, resulting in the target NSD. As a final step, the NF ontology is enriched with the new decompositions. It is also possible to enrich the NF ontology with new standards and new services. Please note that the goal of this disclosure is not to describe the details of the NS design method but to show how the process is enacted using the disclosed method and tool. FIG. 12 illustrates an example of a process model 1200 for NS design according to one embodiment. The process model is later translated to a transformation chain 1300 illustrated in FIG. 13.

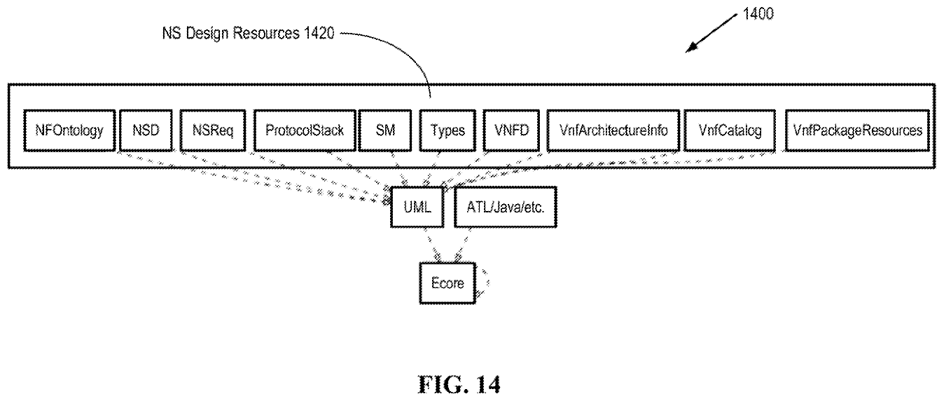

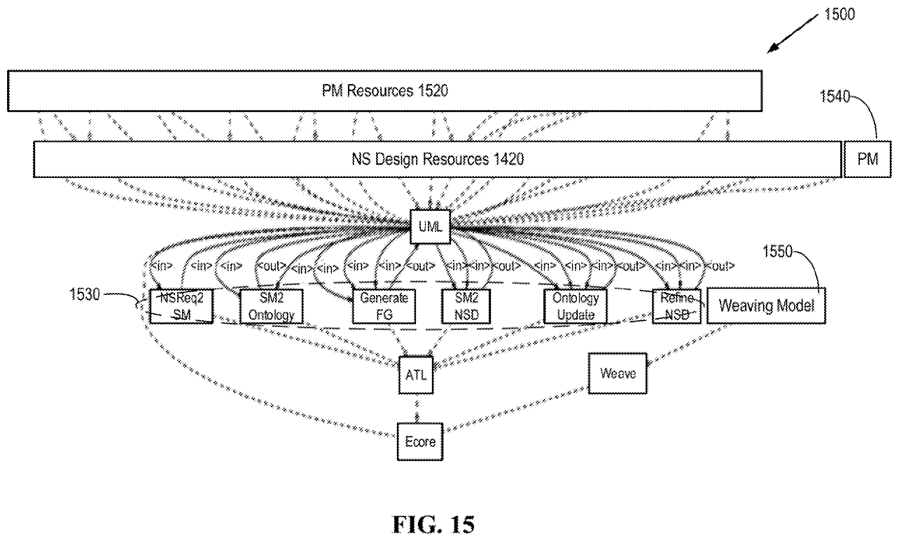

FIG. 14 and FIG. 15 illustrate the construction of a megamodel incrementally. The dashed links represent conformance relationship, and the solid black links represent object flow. To begin with, the NS design resources 1420 (e.g. profiles or meta-models for NSReq, NFOntology, etc.) in the workspace of NS design are registered with an initial megamodel 1400 (FIG. 14). This initial megamodel 1400 also includes the meta-metamodels (UML and Ecore pre-loaded) and conformance links.

FIG. 15 illustrates a megamodel 1500 after process model registration according to one embodiment. The process model registration automatically refines the initial megamodel 1400 with additional resources (e.g. PM resources 1520) in the process model to generate the megamodel 1500. Each transformation (which is associated with an action in the process model) is stored as an attribute of a corresponding activity node (e.g. six such activity nodes 1530 are shown). The process model itself is also added as a resource (shown as PM 1540). A weaving model 1550 is also added into the megamodel 1500. While discovering and registering the process model, whenever an object flow links two pins and that flow and pins do not have any assigned name, the system can detect it and create an intermediate model. This step resulted in creating a repository of models, NFV-specific languages, and tools along with the relationships between the artifacts.

When a request is received to enact the process model, the NS design process model 1200 is mapped to the transformation chain 1300 (FIG. 13). The system enacts the NS design process model 1200 by executing the transformation chain 1300. The process model enactment begins by taking NSReq models as inputs and creating an intermediate model, SolutionMap, which is incrementally refined. Once the initial NSD is created, the system enables NSD refinement and ontology enrichment to be carried out concurrently since they are independent of each other, hence optimizing deployment time. The enactment ends with the generation of the target models, NSD and NFOntology. With this environment, NFV users with limited modeling expertise and minimal knowledge about the underlying transformations can generate a target NSD with basically a few clicks. The configurations for ATL, making sure that the correct models are passed into each transformation, do not need to be handled by the user. The same process model 1200 can be enacted again with different inputs if desired, and it can also be reused as part of another process model as needed.

The process model enactment approach described above has been applied to the enactment of the entire NS design and management process. NS lifecycle management includes, among others, the activities such as onboarding, instantiation, configuration, scaling, update, and termination of network services. Each activity in the NS lifecycle management involves a complex chain of tasks (i.e. actions), which may be modeled by a process model. The process model can then be mapped on to a composite chain of transformations along with a megamodel to allow for automated deployment and management of network services.

A tool has been implemented in the form of an extension of Papyrus/Eclipse. However, a person skilled in the art would understand that a similar tool could be based on another language, technology, or development tool(s). In one embodiment, the resulting tool targets network service designers.

The tool hides megamodels from users to prevent users from damaging the megamodels inadvertently with incorrect addition. The megamodel is manipulated through an interface (a user interface for the user and an API for the developer). A user may have several megamodels at the same time. The tool is extensible. The tool adapts to any technology, any transformation type/engine, and any structure of the process model. In the following, an overview of the user interface of the tool is provided.

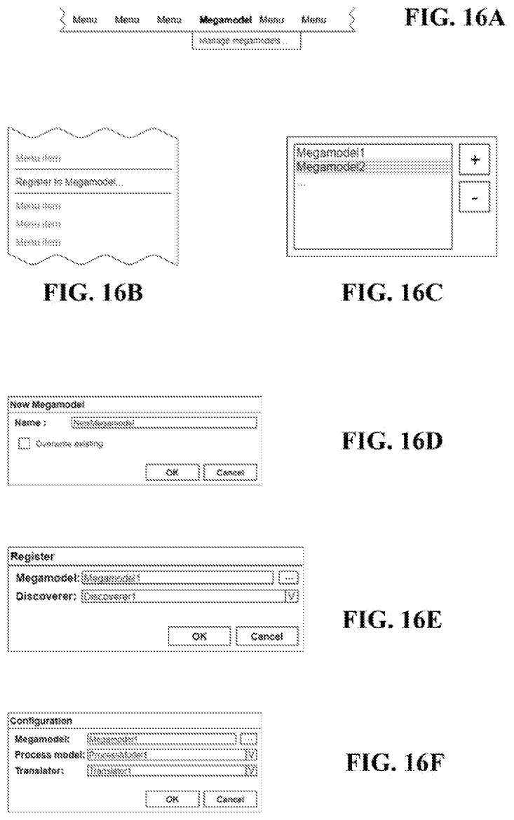

The user interface provides two types of menu: a global menu which allows the user to access the global operations on megamodel (FIG. 16A), and a contextual menu which allows for adding the selected resource to a megamodel (FIG. 16B).

FIG. 16C illustrates a simple component for managing megamodels. This component is based on a “list” widget, that is, a component that holds a list of elements and with which a user can select one of the elements. Next to this widget, there are two buttons: add (+) and remove (−). The latter simply remove the selected megamodel (if any) after confirmation. As for the former, it pops up the dialog laid out in FIG. 16D, which allows to create a new megamodel and add it to the list.

A megamodel is specified by its name. The system will deny the creation of a megamodel with the same name as an already existing one, unless the “Overwrite existing” checkbox has been checked. Additionally, the validity of the megamodel's name is verified. In case the name is not valid, the “OK” button is disabled, preventing the user to accept an invalid name, and an error message is printed in the dialog (e.g. below the title).

When selecting the menu entry “Register to Megamodel . . . ” (FIG. 16B), a user can access a dialog for the registration of a megamodel (FIG. 16E). This menu entry allows the user to select the megamodel in which to register the selected resource, and to select the discoverer for doing so through a widget for selecting from a list of options. When selecting the “ . . . ” button on the right side of the area next to “Megamodel”, a dialog pops up with the megamodel selection component in it (as defined in FIG. 16C), asking the user to select a megamodel.

As an example, Eclipse's launch configuration system (accessible via the “Run” menu) may be used for the enactment of a process model. A process model launch configuration is characterized by a megamodel, a process model and a specific translator (provided through an extension point). Eclipse enables a user to define a custom UI to manage the configuration, an example of which is presented in FIG. 16F.

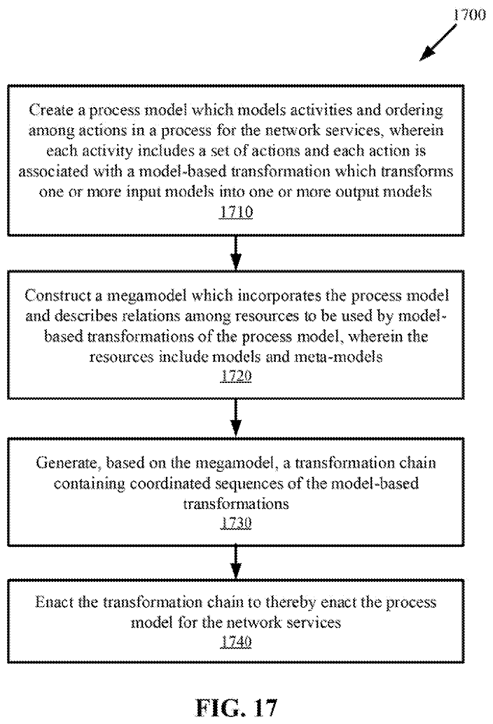

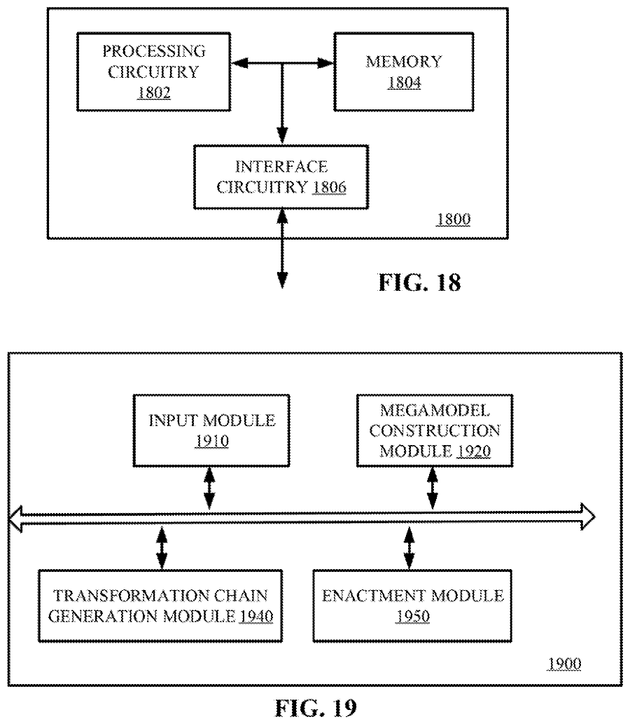

FIG. 17 is a flow diagram of a method 1700 for automating the design and management of network services, such as NSD generation and NS network service lifecycle management. In one embodiment, the method 1700 may be performed by a system such as the enactment system 800 of FIG. 8. The method 1700 may also be performed by any of the systems, network nodes, and environments described in connection with FIGS. 18-21.

The method 1700 begins with the system at step 1710 obtaining a process model which models activities and ordering among actions in a process for the network services. Each activity includes a set of actions and each action is associated with a model-based transformation which transforms one or more input models into one or more output models. The system at step 1720 constructs a megamodel which incorporates the process model and describes relations among resources to be used by model-based transformations of the process model. The resources include models and meta-models. The system at step 1730 generates, based on the megamodel, a transformation chain containing coordinated sequences of the model-based transformations. The system at step 1740 enacts the transformation chain to thereby enact the process model for the network services.

FIG. 18 a block diagram illustrating a network node 1800 according to an embodiment. In one embodiment, the network node 1800 may be a server in an operator network or in a data center. The network node 1800 includes circuitry which further includes processing circuitry 1802, a memory 1804 or instruction repository and interface circuitry 1806. The interface circuitry 1806 can include at least one input port and at least one output port. The memory 1804 contains instructions executable by the processing circuitry 1802 whereby the network node 1800 is operable to perform the various embodiments described herein.

FIG. 19 is a block diagram of an example network node 1900 according to another embodiment. The network node 1900 may be adapted for automating design and management of network services. The network node 1900 includes an input module 1910, a megamodel construction module 1920, a transformation chain generation module 1930 and an enactment module 1940 adapted to perform, respectively, steps 1710, 1720, 1730 and 1740 of the method 1700 of FIG. 17. The network node 1900 can be configured to perform the various embodiments as have been described herein.

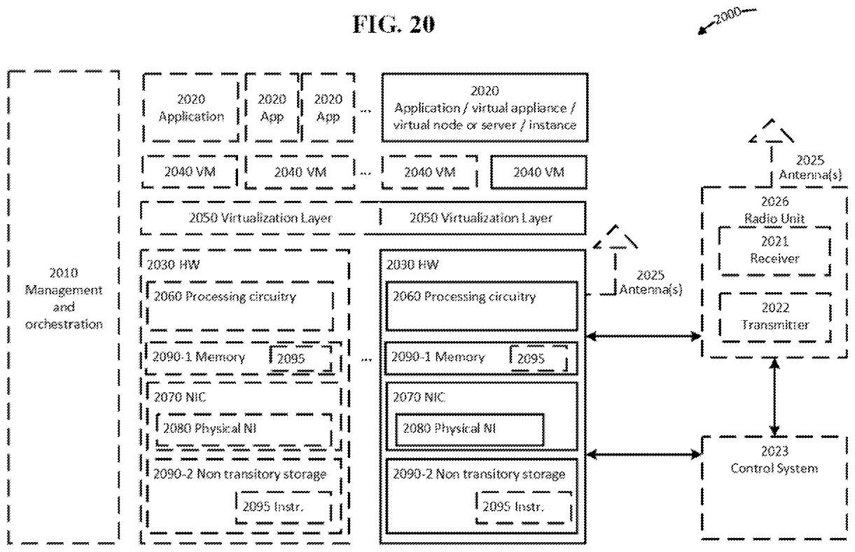

FIG. 20 is a schematic block diagram illustrating a virtualization environment 2000 in which functions implemented by some embodiments may be virtualized/implemented. In the present context, virtualizing means creating virtual versions of apparatuses or devices which may include virtualizing hardware platforms, storage devices and networking resources. As used herein, virtualization can be applied to a node (e.g., a virtualized base station, a virtualized radio access node, or any other node) or to a device (e.g., a user equipment (UE), a wireless device or any other type of communication device) or components thereof and relates to an implementation in which at least a portion of the functionality is implemented as one or more virtual components (e.g., via one or more applications, services, components, functions, virtual machines or containers executing on one or more physical processing nodes in one or more networks).

In some embodiments, some or all of the functions described herein may be implemented as virtual components executed by one or more virtual machines implemented in one or more virtual environments 2000 hosted by one or more of hardware nodes 2030. Further, in embodiments in which the virtual node is not a radio access node or does not require radio connectivity (e.g., a core network node), then the network node may be entirely virtualized.

The functions may be implemented by one or more applications 2020 (which may alternatively be called software instances, virtual appliances, network functions, virtual nodes, virtual network functions, etc.) operative to implement some of the features, functions, and/or benefits of some of the embodiments disclosed herein. Applications 2020 are run in virtualization environment 2000 which provides hardware 2030 comprising processing circuitry 2060 and memory 2090. Memory 2090 contains instructions 2095 executable by processing circuitry 2060 whereby application 2020 is operative to provide one or more of the features, benefits, and/or functions disclosed herein.

Virtualization environment 2000, comprises general-purpose or special-purpose network hardware devices 2030 comprising a set of one or more processors or processing circuitry 2060, which may be commercial off-the-shelf (COTS) processors, dedicated Application Specific Integrated Circuits (ASICs), or any other type of processing circuitry including digital or analog hardware components or special purpose processors. Each hardware device may comprise memory 2090-1 which may be non-persistent memory for temporarily storing instructions 2095 or software executed by processing circuitry 2060. Each hardware device may comprise one or more network interface controllers (NICs) 2070, also known as network interface cards, which include a physical network interface 2080. Each hardware device may also include non-transitory, persistent, machine-readable storage media 2090-2 having stored therein software 2095 and/or instructions executable by processing circuitry 2060. Software 2095 may include any type of software including software for instantiating one or more virtualization layers 2050 (also referred to as hypervisors), software to execute virtual machines 2040 as well as software allowing it to execute functions, features and/or benefits described in relation with some embodiments described herein.

Virtual machines 2040, comprise virtual processing, virtual memory, virtual networking or interface and virtual storage, and may be run by a corresponding virtualization layer 2050 or hypervisor. Different embodiments of the instance of virtual appliance 2020 may be implemented on one or more of virtual machines 2040, and the implementations may be made in different ways.

During operation, processing circuitry 2060 executes software 2095 to instantiate the hypervisor or virtualization layer 2050, which may sometimes be referred to as a virtual machine monitor (VMM). Virtualization layer 2050 may present a virtual operating platform that appears like networking hardware to virtual machine 2040.

As shown in FIG. 20, hardware 2030 may be a standalone network node with generic or specific components. Hardware 2030 may comprise antenna 2025 and may implement some functions via virtualization. Alternatively, hardware 2030 may be part of a larger cluster of hardware (e.g. such as in a data center or customer premise equipment (CPE)) where many hardware nodes work together and are managed via management and orchestration (MANO) 2010, which, among others, oversees lifecycle management of applications 2020.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 2040 may be a software implementation of a physical machine that runs programs as if they were executing on a physical, non-virtualized machine. Each of virtual machines 2040, and that part of hardware 2030 that executes that virtual machine, be it hardware dedicated to that virtual machine and/or hardware shared by that virtual machine with others of the virtual machines 2040, forms a separate virtual network element (VNE).

Still, in the context of NFV, Virtual Network Function (VNF) is responsible for handling specific network functions that run in one or more virtual machines 2040 on top of hardware networking infrastructure 2030 and corresponds to application 2020 in FIG. 20.

In some embodiments, one or more radio units 2026 that each includes one or more transmitters 2022 and one or more receivers 2021 may be coupled to one or more antennas 2025. Radio units 2026 may communicate directly with hardware nodes 2030 via one or more appropriate network interfaces and may be used in combination with the virtual components to provide a virtual node with radio capabilities, such as a radio access node or a base station.

In some embodiments, some signaling can be effected with the use of control system 2023 which may alternatively be used for communication between the hardware nodes 2030 and radio units 2026.

The above-described embodiments are intended to be examples only. Alterations, modifications and variations may be effected to the particular embodiments by those of skill in the art.

1. A method for automating design and management of network services, comprising:
obtaining a process model which models activities and ordering among actions in a process for the network services, wherein each activity includes a set of actions and each action is associated with a model-based transformation which transforms one or more input models into one or more output models;
constructing a megamodel which incorporates the process model and describes relations among resources to be used by model-based transformations of the process model, wherein the resources include models and meta-models;
generating, based on the megamodel, a transformation chain containing coordinated sequences of the model-based transformations; and
enacting the transformation chain to thereby enact the process model for the network services.

2. The method of claim 1, wherein enacting the transformation chain further comprises:
invoking one or more language handlers to execute the transformation chain.

3. The method of claim 2, wherein the one or more language handlers include pluggable handlers for model transformation languages and other executable code.

4. The method of claim 1, wherein constructing the megamodel further comprises:
building a weaving model which maps every element in the process model to a corresponding resource in the megamodel; and
incorporating the weaving model into the megamodel.

5. The method of claim 1, wherein constructing the megamodel further comprises:
incorporating the model-based transformations into the megamodel;
linking the model-based transformations with one or more language handlers in the megamodel; and
linking the model-based transformations with respective in-out resources in the megamodel.

6. The method of claim 1, wherein constructing the megamodel further comprises:
registering with an initial megamodel the resources discovered in a workspace for the network services; and
incrementing the initial megamodel by further registering the process model and the model-based transformations of the process model.

7. The method of claim 1, wherein the coordinated sequences of the model-based transformations are coordinated through forks and joins.

8. The method of claim 1, wherein each resource in the megamodel is provided with traceability attributes.

9. The method of claim 1, wherein the traceability attributes include one or more of: a history that traces past events of the resource, a timestamp and an origin.

10. The method of claim 1, wherein the model-based transformations include models and executable programs.

11. A network node comprising:
processing circuitry; and
memory to store instructions executable by the processing circuitry to automate design and management of network services,
the network node operative to:
obtain a process model which models activities and ordering among actions in a process for the network services, wherein each activity includes a set of actions and each action is associated with a model-based transformation which transforms one or more input models into one or more output models;
construct a megamodel which incorporates the process model and describes relations among resources to be used by model-based transformations of the process model, wherein the resources include models and meta-models;
generate, based on the megamodel, a transformation chain containing coordinated sequences of the model-based transformations; and
enact the transformation chain to thereby enact the process model for the network services.

12. The network node of claim 11, wherein the network node when enacting the transformation chain is further operative to:
invoke one or more language handlers to execute the transformation chain.

13. The network node of claim 12, wherein the one or more language handlers include pluggable handlers for model transformation languages and other executable code.

14. The network node of claim 11, wherein the network node when constructing the megamodel is further operative to:
build a weaving model which maps every element in the process model to a corresponding resource in the megamodel; and
incorporate the weaving model into the megamodel.

15. The network node of claim 11, wherein the network node when constructing the megamodel is further operative to:
incorporate the model-based transformations into the megamodel;
link the model-based transformations with one or more language handlers in the megamodel; and
link the model-based transformations with respective in-out resources in the megamodel.

16. The network node of claim 11, wherein the network node when constructing the megamodel is further operative to:
register with an initial megamodel the resources discovered in a workspace for the network services; and
increment the initial megamodel by further registering the process model and the model-based transformations of the process model.

17. The network node of claim 11, wherein the coordinated sequences of the model-based transformations are coordinated through forks and joins.

18. The network node of claim 11, wherein each resource in the megamodel is provided with traceability attributes.

19. The network node of claim 11, wherein the traceability attributes include one or more of: a history that traces past events of the resource, a timestamp and an origin.

20. The network node of claim 11, wherein the model-based transformations include models and executable programs.

21. (canceled)
